(19) United States
(12) Patent Application Publication
(10) Pub. No.: US 2014/0324563 A1
(43) Pub. Date: Oct. 30, 2014

(54) CONSUMER INCENTIVE AND/OR LOYALTY PROGRAM

(71) Applicant: World Wide Wencel, LLC, Oak Brook, IL (US)

(72) Inventor: Michael J. Wencel, II, Oak Brook, IL (US)

(73) Assignee: World Wide Wencel, LLC, Oak Brook, IL (US)

(21) Appl. No.: 14/072,546

(22) Filed: Nov. 5, 2013

Related U.S. Application Data
(60) Provisional application No. 61/829,636, filed on May 31, 2013.
(60) Provisional application No. 61/816,586, filed on Apr. 26, 2013.

(51) Int. Cl. G06Q 30/02

(52) U.S. Cl. CPC G06Q 30/0226
USPC 705/14.27

(57) ABSTRACT

A consumer incentive and rewards program includes accessing a consumer rewards application, establishing a new account or creating a link between the application and an existing account, capturing an image of a proof of purchase, such as a register receipt, determining a type of information on the proof of purchase and, if the information is direct machine readable, extracting product or service information from the proof of purchase, and if the information on the proof of purchase is not direct machine readable, converting the information into a direct machine readable form, calculating a rewards points value or other incentive based on the product information and posting the calculated points value or other incentive to the account. The information can be collected, stored and analyzed for marketing research. A software system stored in a computer-readable medium for posting a rewards point value or other incentive is also disclosed.

### BACKGROUND

Consumer rewards or loyalty programs are well known. Some programs are in the form of targeted incentive programs that produce increased revenue streams and track consumer purchasing habits. These programs increase consumer retention and as such profitability by targeting specific products and services to consumers based on prior product and service purchasing behavior. Such programs can also be used to introduce new products and services and to motivate consumers to try new products and services that are related to prior purchase histories.

In one form of known program, consumers provide registration information and physically or electronically send or email register receipts or other proof of purchase to a manufacturer or third party to record such purchases. The purchases are then recorded and analyzed to, for example, record redemption or reward points, send coupons, redemption certificates, sale information and the like.

Web based applications are also known for tracking individual's purchases. While such web-based applications facilitate organization to, for example, organize receipts for tax and warranty matters, such applications are only tracking and storage vehicles and do not provide an interface to consumer reward and/or loyalty programs.

Accordingly, there is a need for an electronic web-based consumer reward program. Desirably, such a program facilitates tracking and storage of individual consumer purchases. More desirably, such a program automatically uploads individual purchase information from a proof of purchase, such as a consumer receipt into that individual's account through a web based application. More desirably still, such a program links the individual's purchase information to that individual's account for purposes of tracking, analyzing and creating individually tailored incentives while tracking and accumulating consumer reward and/or loyalty points or other incentives, for example, for later redemption.

### SUMMARY

An application accessed consumer rewards program is an electronic web-based consumer reward program that facilitates tracking and storage of individual customer purchases through a proof of purchase, such as a cash register or other customer receipt. In an embodiment the program automatically uploads individual purchase information from the proof of purchase into that individual's account through a web based application. Such a program can link the individual's purchase information to that individual's account for purposes of tracking, analyzing and creating individually tailored incentives while tracking and accumulating consumer reward and/or loyalty points or other incentives, for example, for later redemption.

In an embodiment, the program includes downloading to a smart device, a consumer rewards application. A new consumer rewards account can be established or a link can be created between the application and an existing account. The consumer rewards application can be accessed and an image of a proof of purchase, such as a register receipt, for a product or service is captured by for example, a camera on the smart device. The type of information on the proof of purchase is determined and, if the information is direct machine readable, product or service information is extracted from the register receipt. If the information on the proof of purchase is not direct machine readable, the information is converted into a direct readable form.

A rewards points value or other incentive is calculated based on the extracted product information and the calculated points value or other incentive and is posted to the new or existing account.

In an embodiment multiple new accounts can be established or links can be created between the application and one or more existing accounts.

In a further embodiment, the rewards program includes capturing a second image of the proof of purchase for a different product or service, determining the type of information on the proof of purchase for the different product or service and, if the information is direct machine readable, extracting product or service information for the different product or service from the proof of purchase. If the information on the proof of purchase is not direct machine readable, the information is converted into a direct readable form. A reward points value or other incentive is calculated for the different product or service based on the extracted product information and the calculated points value or other incentive is posted to the new or existing account associated with the different product or service.

In a further embodiment, the steps of capturing the second image on the proof of purchase for a different product or service, determining the type of information on the proof of purchase for the different product or service and, if the information is direct machine readable, extracting product or service information for the different product or service from the proof of purchase, and if the information is on the proof of purchase is not direct machine readable, converting the information into a direct readable form and calculating a rewards points value or other incentive for the different product or service based on the extracted product information, and posting the calculated points value or other incentive to the new or existing account associated with the different product or service are automatically carried out following the step of posting the calculated points value to the new or existing account.

In a still further embodiment, the steps of capturing the second image on the proof of purchase for a different product or service, determining the type of information on the proof of purchase for the different product or service and, if the information is direct machine readable, extracting product or service information for the different product or service from the proof of purchase, and if the information is on the proof of purchase is not direct machine readable, converting the information into a direct readable form and calculating a rewards points value or other incentive for the different product or service based on the extracted product information, and posting the calculated points value or other incentive to the new or existing account associated with the different product or service are carried out by action of a command following the step of posting the calculated points value or other incentive to the new or existing account.

The present consumer rewards program can be embodied in other forms. For example, the program can be embodied as a software system stored in a computer-readable medium for posting a rewards point value or other incentive. Such a system can include a first routine that downloads to a smart device, a consumer rewards application, a second routine that establishes a new account or creates a link between the application and an existing account and a third routine that accesses the consumer rewards application.

The system can further include a fourth routine that captures an image of a proof of purchase for a product or service, a fifth routine that determines a type of information on the proof of purchase and, if the information is direct machine readable, extracting product or service information from the proof of purchase, and if the information on the proof of purchase is not direct machine readable, converting the information into a direct machine readable form, a sixth routine that calculates a rewards points value or other incentive based on the extracted product information and a seventh routine that posts the calculated points value or other incentive to the new or existing account.

Further embodiments can include a routine that establishes multiple new accounts or creates links between the application and one or more existing accounts.

Still further embodiments can include an eighth routine that captures a second image on the proof of purchase for a different product or service, a ninth routine that determines the type of information on the proof of purchase for the different product or service and, if the information is direct machine readable, extracting product or service information for the different product or service from the proof of purchase, and if the information on the proof of purchase is not direct machine readable, converting the information into direct machine readable form, a tenth routine that calculates a rewards points value or other incentive for the different product or service based on the extracted product information and an eleventh routine that posts the calculated points value or other incentive to the new or existing account associated with the different product or service.

In still further embodiments, the eighth routine can be carried out automatically following the seventh routine and the eighth routine can be carried out by a command following the seventh routine.

In yet another embodiment of the rewards program, an application accessed consumer rewards program method includes the steps of accessing a consumer rewards application, establishing a new account or creating a link between the consumer rewards application and an existing account, accessing the consumer rewards application and capturing an image of a proof of purchase for a product or service. The method further includes transmitting the image to a remote device, and determining, on the remote device, a type of information on the proof of purchase. If the information is direct machine readable, extracting product or service information from the proof of purchase, and if the information on the proof of purchase is not direct machine readable, converting the information into a direct machine readable form.

The method further includes calculating a rewards points value or other incentive based on the extracted product information and posting the calculated points value or other incentive to the new or existing account.

The method can include the steps of capturing the image and transmitting the images being carried out on a smart device, and the step of transmitting from the remote device one or more messages to acknowledge receipt of the image, validation and/or processing of the rewards point value, and posting of the calculated points value or other incentive to the new or existing account.

The method can further include transmitting the image by upload to a server by accessing the consumer rewards application through a web application or by transmitting through, for example, a text message.

The proof of purchase can be provided by electronic means, such as by electronic delivery to a computer, smart device or the like, via email, wirelessly via bluetooth or other protocol. In such an embodiment, the proof of purchase can be captured electronically from the transmitted electronic receipt and directly uploaded to the rewards program application.

Other objects, features, and advantages of the disclosure will be apparent from the following description, taken in conjunction with the accompanying sheets of drawings, wherein like numerals refer to like parts, elements, components, steps, and processes.

### BRIEF DESCRIPTION OF THE DRAWINGS

The benefits and advantages of the present device will become more readily apparent to those of ordinary skill in the relevant art after reviewing the following detailed description and accompanying and drawings, wherein:

FIG. 1 is a flow chart showing the process for establishing a single product consumer reward program account;

FIG. 2 is a flow chart showing the process for establishing multiple product consumer reward program accounts;

FIG. 3 is a flow chart showing the process for capturing purchase information for a single product consumer reward program account;

FIG. 4 is a flow chart showing the process for capturing purchase information for multiple product consumer reward program accounts; and

FIGS. 5A-5D are flow charts showing alternate processes for capturing, transmitting, calculating and assigning awards for a consumer rewards program and optional steps in the execution of the program.

### DETAILED DESCRIPTION

While the present disclosure is susceptible of embodiment in various forms, there is shown in the drawings and will hereinafter be described a presently preferred embodiment with the understanding that the present disclosure is to be considered an exemplification of the disclosed system and method and is not intended to be limited to the specific embodiment or embodiments illustrated.

A consumer rewards or loyalty program facilitates the tracking and storage of individual consumer (user) purchase information, analyzes that information, generates points, credits or other incentives toward the purchases and stores the generated points, credits or other incentive and generates targeted incentives and/or rewards for the individual consumer based on the stored information. The program tracks purchases through capturing a proof of purchase, such as a customer (cash register) receipt, or other proof, such as a code on a code-carrying element or the like, as is described in detail herein.

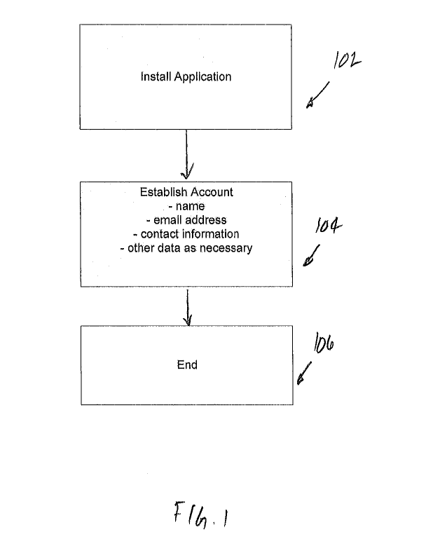

In an embodiment, as shown in FIG. 1 at block 102, the user installs, such as by downloading, an application to, for example, a smart phone, PDA or other device (collectively, “smart device”), that includes a camera. An account is established at block 104 by the user that is linked to, e.g., communicates with, the application. The account can be established through the smart device or through a website, for example, using a computer. In one embodiment, the application is product or retailer/manufacturer specific. For example, the application can be specific for brand XYZ laundry detergent, or the application can be more general for all laundry product or perhaps all products manufactured or distributed by company ABC. The installation can then be closed at block 106.

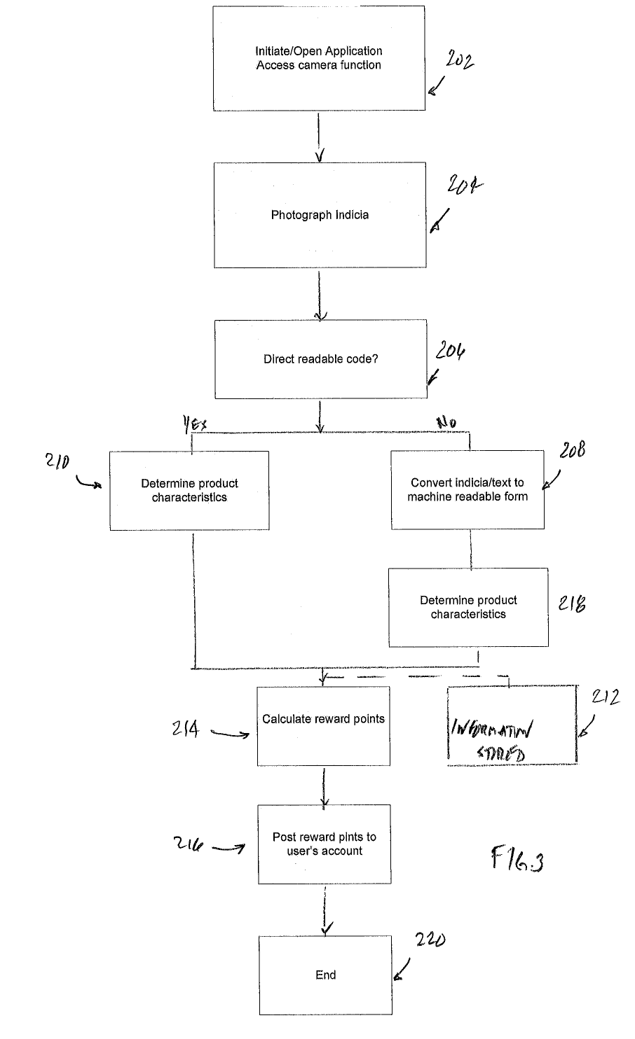

As seen in FIG. 3, in use, the application is opened at block 202 and includes or accesses the camera through a camera application, such as the iSight camera on Apple's iPhone. The proof of purchase, such as the register receipt, is photographed at block 204. The image captured can be a barcode, a QR code, or the text or other indicia present on a register receipt and the application determines whether the image is direct readable code or text/indicia at block 206. If text is captured, at block 208, the application accesses an optical character recognition (OCR) or other program for converting the text or other indicia into machine-encoded text. In an exemplary operation, when the application is opened, the camera is activated allowing the user to take a photograph of the text/indicia, barcode or QR code on the register receipt.

Once the photo is taken and submitted, a program determines the type of information on the receipt. If the information on the receipt is a barcode or QR code, at block 210, specific product information or characteristics are extracted from the barcode or QR code such as size, price, etc. of the product. The information can also be stored for later use and/or analysis as at block 212. From those characteristics, reward points are calculated at block 214 and uploaded or posted to the individual's account at block 216.

If the information on the receipt is indicia or text based (at block 208), the OCR program deciphers the information and converts that information at block 218 into specific product information or characteristics such as product size, price, etc. The information can also be stored for later use and/or analysis at block 212. From those characteristics, reward points are calculated at block 214 and uploaded or posted to the individual's account at block 216. The application can then be closed at block 220.

A user can access his/her account or redeem points for rewards from the associated brands reward program through, for example, the application or a website.

In addition to the information being used to calculate reward points for that particular purchase, other information on the receipt can be recorded, stored and analyzed. For example, if in addition to XYZ brand laundry detergent, QRS brand fabric softener is also purchased, information regarding that purchase can be determined and stored, whether QRS brand fabric softener is from the same manufacturer/distributor or a different manufacturer/distributor. This information can be used, for example, to instantly, or at some later time, email, text or otherwise send to the user coupons, promotions and/or other incentives for product purchase.

It will be understood that the proof of purchase can be provided in a number of ways. One example, as disclosed herein, is through the capture of information on a customer or register (cash register) receipt. Another way in which proof of purchase can be captured is, for example, by capturing a code (for example, a bar code) on a card or other media provided by a service supplier. As an illustrative example, at a hair salon, a haircut may be valued at 5 points while a manicure maybe valued at 2 points. A card or other media that bears a code, such as a bar code, may be held by a salon attendant, when the consumer pays for the particular service, the attendant may then allow the consumer to capture (take a photograph) of the code for that service, after which the assigned points value or other incentive is posted to that consumer's account. It will be appreciated that such a method can be to award point values in a wide variety of industries and that all such uses are within the scope and spirit of the present disclosure.

It will also be understood that in addition to, or in lieu of the posting of points values, other promotions or incentive programs can be entered into using the present system. For example, the capture and registering of a proof of purchase can be used to enter a sweepstakes, prize drawing or other contest.

It is contemplated that proof of purchase or register receipt data can initially be divided into two groups or segments. One group may contain, for example, specific information related to the sale and purchases for the brand rewards program. The second group may contain, for example, additional product and/or service sales data relating to that consumers' purchasing traits. This research group can contain information relating to particular purchases at a specific time. This information can then be subdivided and categorized in, for example, alphabetical order, product attributes and other characteristics for later analysis. It is anticipated that such research files can be compatible with Nielson or IRI data formats.

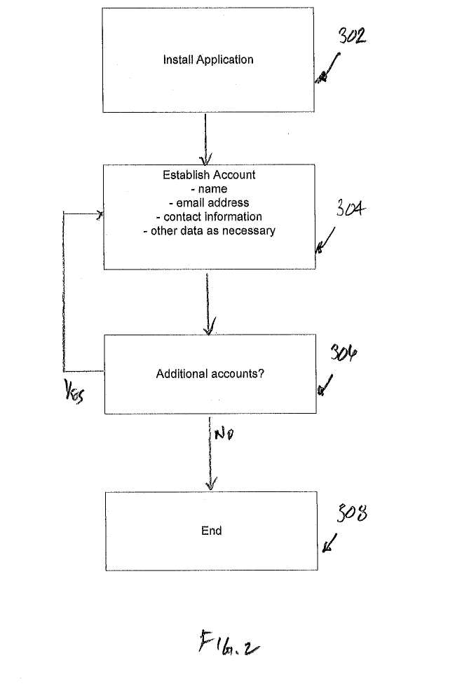

In another embodiment, as seen in FIG. 2, a smart device application allows users to access more than one rewards programs through a single application which, for purposes of this discussion, will be referred to as a snap shot rewards application or program. For example, smaller retailers or manufacturers/distributors may not have the means to support a stand-alone application. In such a scenario, a user downloads the snap shot rewards program application at block 302 to a smart device and establishes an account through the smart device (through the application) or through a website, for example, using a computer.

The application can be associated with rewards programs from multiple retailers, manufacturers and/or distributors. For example at block 304, the user can enter his/her rewards program account information for retailer DEF. Once that account is established, the application ask whether additional accounts are to be established at block 306. If additional accounts are to be established or if existing accounts are to be associated with the application, the user will enter the appropriate account data, for example, retailer GHI and manufacturers JKL and MNO, all of which are associated with the snap shot rewards program, in repeated cycles at block 304. The installation, establishment or linking of accounts can then be closed at block 308.

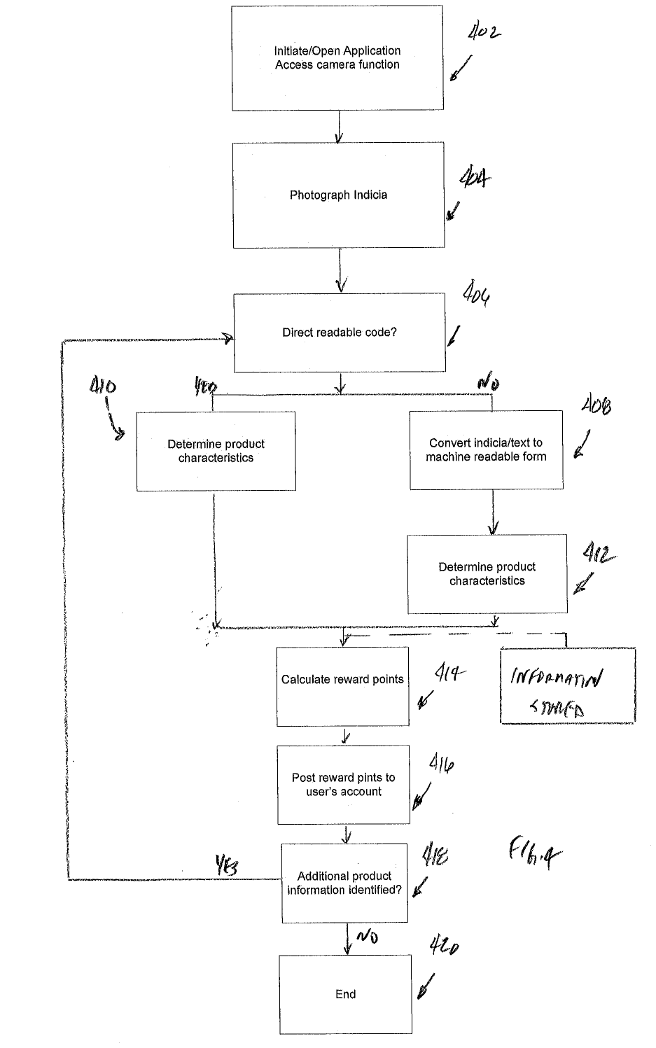

In use, referring to FIG. 4, after a purchase, the users open the application at block 402 which accesses the camera through a camera application and the image on the proof of purchase (e.g., register receipt) is captured at block 404. As noted above, the application determines whether the image can be direct readable code for example, a barcode, a QR code, or the text or other indicia present on a register receipt at block 406. If text is captured, the application accesses an optical character recognition (OCR) or other program for converting the text or other indicia into machine-encoded text at block 408. In an exemplary operation, when the application is opened, the camera is activated allowing the user to take a photograph of the text/indicia, barcode or QR code on the register receipt.

Once the photo is taken and submitted, a program determines the type of information on the receipt at block 406. If the information on the receipt is a direct readable code such as a barcode, QR code or the like, specific product information or characteristics are extracted from the barcode or QR code such as the product, the size, price, etc. of the product at block 410. If the information on the receipt is indicia or text based, the OCR program deciphers the information and converts that information into specific product information or characteristics such as the product, the product size, price, etc. at block 412.

The product information is then matched with the appropriate rewards program, such as DEF's and GHI's programs (even if on the same receipt), and reward points or other incentive is calculated at block 414 and uploaded or posted to the individual's appropriate account at block 416. Again, the information can also be stored for later use and/or analysis.

If information is determined to apply to another rewards program account at block 418, the application can automatically return to block 406 or be manually returned, as by a command, to determine whether that other information is direct readable code or requires conversion to machine readable form. If the information is direct readable code, at block 410, specific product information or characteristics are extracted from the barcode or QR code such as the product, the size, price, etc. of the product. If the information is not direct readable and requires conversion (e.g., through an OCR), the information is converted at block 408 and specific product information or characteristics are extracted and determined from the barcode or QR code such as the product, the size, price, etc., at block 412, the rewards points are calculated at block 414, and the points posted to the user's account at block 416. Once all of the information is extracted from the register receipt, the application can be closed at block 420.

The present consumer rewards program allows a user to purchase a number of products or services, of several brands, which can benefit the consumer as well as the marketer and or retailer.

The present consumer rewards program can be embodied in numerous forms. For example, the program can be embodied as a software system stored in a computer-readable medium for posting a rewards point value. Such a system can include a first routine that downloads to a smart device as at block 102, a consumer rewards application, a second routine as at block 104 that establishes a new account or creates a link between the application and an existing account and a third routine as at block 202 that accesses the consumer rewards application.

The system can further include a fourth routine as at block 204 that captures an image of a proof of purchase, such as a register receipt, for a product or service, a fifth routine as at block 206 that determines a type of information on the register receipt and, if the information is direct machine readable as at block 210, extracting product or service information from the register receipt, and if the information on the register receipt is not direct machine readable, as at block 208 converting the information into a direct machine readable form, a sixth routine as at block 214 that calculates a rewards points value or other incentive based on the extracted product information and a seventh routine as at block 216 that posts the calculated points value or other incentive to the new or existing account.

Further embodiments can include a routine that establishes multiple new accounts or creates links between the application and one or more existing accounts as at blocks 304 and 306.

Still further embodiments can include an eighth routine that, as at block 404, captures a second image on the proof of purchase, such as the register receipt, for a different product or service, a ninth routine as at block 406 that determines the type of information on the register receipt for the different product or service and, if the information is direct machine readable as at block 410, extracting product or service information for the different product or service from the register receipt, and if the information on the register receipt is not direct machine readable, as at block 408 converting the information into direct machine readable form, a tenth routine as at block 414 that calculates a rewards points value or other incentive for the different product or service based on the extracted product information and an eleventh routine as at block 416 that posts the calculated points value or other incentive to the new or existing account associated with the different product or service.

In still further embodiments, the eighth routine can be carried out automatically following the seventh routine and the eighth routine can be carried out by a command following the seventh routine.

It will be appreciated that the proof of purchase can be provided by electronic means. For example, the proof of purchase can be provided by electronic delivery to a computer, smart device or the like, via email, wirelessly via bluetooth or any other known or not yet known protocol. For example, retailers have begun to “send” receipts electronically to one or more selected email addresses or other personal locations following a purchase. This proof of purchase can be captured electronically from the transmitted electronic receipt and directly uploaded to the rewards program application.

For example, referring to FIG. 3 it is anticipated that such electronically transmitted information, which would be “direct readable” code, would be introduced prior to block 210. The specific product information or characteristics would be extracted from the electronically transmitted information. From those characteristics, reward points are calculated at block 214 and uploaded or posted to the individual's account at block 216. The information can also be stored for later use and/or analysis as at block 212. It is also anticipated that such electronically transmitted information can be used with an application that is associated with rewards programs from multiple retailers, manufacturers and/or distributors, such as that illustrated in FIG. 4 and that such an application would operate in a manner similar to that described above.

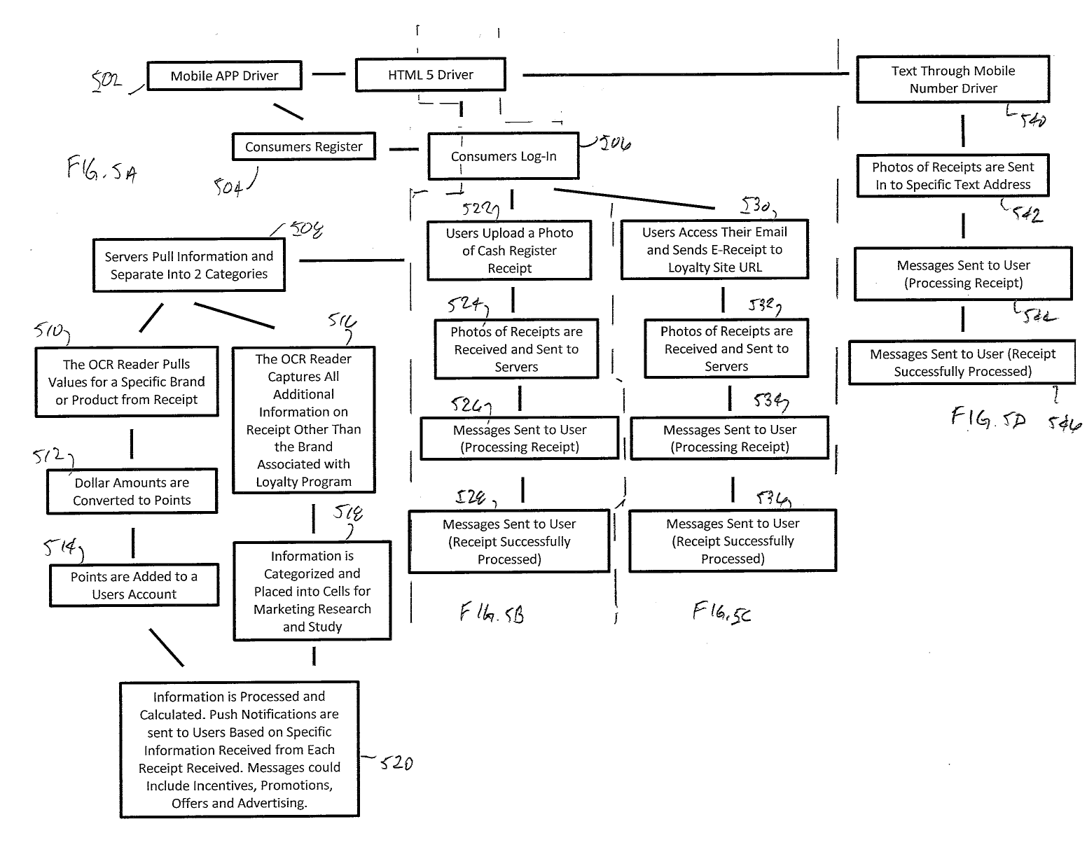

Referring now to FIG. 5A, there is shown flow diagrams for still another embodiment of a consumer rewards program. In block 502, a user accesses the consumer rewards program through a mobile application, and registers, as at block 504, as in the previously disclosed embodiments. The user logs into the program, as at block 506 and information is collected and processed and reward points assigned as at blocks 508-520. Messages can be sent to the user, as at block 520, through push notification, through the consumer rewards application, through text or other messages to a linked telephone number, email address, through the reward program or the like. The messages can include that the image has been received, that reward points calculation is processing/validating, the processing/validation has been completed, and can include additional incentives, promotions, offers, advertisements and the like.

Alternately, as shown in FIG. 5B, the consumer rewards program can be accessed through, for example, an HTML-5 driver at block 502A. Users log in at block 506, in a manner similar to that disclosed previously, upload register receipts as by image capture or upload of electronic receipts at block 522. The information is send to the reward program server at block 524 and a optionally, messages can be sent to the user, as at block 520, through push notification, through the consumer rewards application, through text or other messages to a linked telephone number, email address, through the reward program or the like. The messages can include that the image has been received, that the reward points calculation is processing/validating (block 526), the processing/validation has been completed (block 528), and can include additional incentives, promotions, offers, advertisements and the like.

As shown in FIG. 5C, alternately still, following log in at block 506, a user can access an email account as at block 530, and transmit captured images or electronic information to a server, for example a website hosting the rewards program as at block 532. Messages can then be sent to the user, as at blocks 534 and 536, through push notification, through the consumer rewards application, through text or other messages to a linked telephone number, email address, through the reward program or the like. The messages can include that the image has been received, that the reward points calculation is processing/validating (e.g., as at block 534), the processing/validation has been completed (e.g., as at block 536), and can include additional incentives, promotions, offers, advertisements and the like.

Alternately still, as illustrated in FIG. 5D, a text through mobile number driver can be accessed, as at block 540, and one or more captured images can be uploaded to a text address as at lock 542 for processing in a manner similar to that described above. Again, messages can then be sent to the user, as at blocks 544 and 546, through push notification, through the consumer rewards application, through text or other messages to a linked telephone number, email address, through the reward program or the like. The messages can include that the image has been received, that the reward points calculation is processing/validating (e.g., as at block 544), the processing/validation has been completed (e.g., as at block 546), and can include additional incentives, promotions, offers, advertisements and the like.

It will be appreciated by those skilled in the art that one or more of the steps described in connection with FIGS. 5A-5D can be used in conjunction with many of the method steps of FIGS. 1-4 and that all such combinations of steps and the various scenarios that are contemplated are within the scope and spirit of the present disclosure. It will also be appreciated that modes of communication not yet known may also be incorporated into the present consumer rewards programs and that the use of such not yet known communications modes are also within the scope and spirit of the present consumer rewards programs.

All patents referred to herein, are incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover all such modifications as fall within its scope.

What is claimed is:

1. An application accessed consumer rewards program method comprising the steps of:
downloading to a smart device, a consumer rewards application;
establishing a new account or creating a link between the application and an existing account;
accessing the consumer rewards application;
capturing an image of a proof of purchase for a product or service;
determining a type of information on the proof of purchase and, if the information is direct machine readable,
extracting product or service information from the proof of purchase, and if the information on the proof of purchase is not direct machine readable, converting the information into a direct machine readable form;
calculating a rewards points value or other incentive based on the extracted product information; and
posting the calculated points value or other incentive to the new or existing account.

2. The rewards program of claim 1 including the step of establishing multiple new accounts or creating links between the application and one or more existing accounts.

3. The rewards program of claim 2 including the steps of:
capturing a second image on the proof of purchase for a different product or service;
determining the type of information on the proof of purchase for the different product or service and, if the information is direct machine readable,
extracting product or service information for the different product or service from the proof of purchase, and if the information on the proof of purchase is not direct machine readable, converting the information into direct machine readable form;
calculating a rewards points value or other incentive for the different product or service based on the extracted product information; and
posting the calculated points value or other incentive to the new or existing account associated with the different product or service.

4. The rewards program of claim 3 wherein the steps of capturing the second image on the proof of purchase for a different product or service, determining the type of information on the proof of purchase for the different product or service and, if the information is direct machine readable, extracting product or service information for the different product or service from the proof of purchase, and if the information on the proof of purchase is not direct machine readable, converting the information into a direct machine readable form and calculating a rewards points value or other incentive for the different product or service based on the extracted product information, and posting the calculated points value or other incentive to the new or existing account associated with the different product or service is automatically carried out following the step of posting the calculated points value or other incentive to the new or existing account.

5. The rewards program of claim 3 wherein the steps of capturing the second image on the proof of purchase for a different product or service, determining the type of information on the proof of purchase for the different product or service and, if the information is direct machine readable, extracting product or service information for the different product or service from the proof of purchase, and if the information on the proof of purchase is not direct machine readable, converting the information into a direct machine readable form and calculating a rewards points value or other incentive for the different product or service based on the extracted product information, and posting the calculated points value or other incentive to the new or existing account associated with the different product or service is carried out by action of a command following the step of posting the calculated points value or other incentive to the new or existing account.

6. The rewards program of claim 1 wherein the proof of purchase is a register receipt.

7. The rewards program of claim 3 wherein the proof of purchase for the different product or service is a register receipt.

8. The rewards program of claim 1 wherein the proof of purchase is in the form of electronically transmitted information.

9. A software system stored in a computer-readable medium for posting a rewards point value, comprising:
a first routine that downloads to a smart device, a consumer rewards application;
a second routine that establishes a new account or creates a link between the application and an existing account;
a third routine that accesses the consumer rewards application;
a fourth routine that captures an image of a proof of purchase for a product or service;
a fifth routine that determines a type of information on the proof of purchase and, if the information is direct machine readable, extracting product or service information from the proof of purchase, and if the information on the proof of purchase is not direct machine readable, converting the information into a direct machine readable form;
a sixth routine that calculates a rewards points value or other incentive based on the extracted product information; and
a seventh routine that posts the calculated points value or other incentive to the new or existing account.

10. The software system of claim 9 further including a routine that establishes multiple new accounts or creates links between the application and one or more existing accounts.

11. The software system of claim 10 that includes
an eighth routine that captures a second image on the proof of purchase for a different product or service,
a ninth routine that determines the type of information on the proof of purchase for the different product or service and, if the information is direct machine readable, extracting product or service information for the different product or service from the proof of purchase, and if the information on the proof of purchase is not direct machine readable, converting the information into direct machine readable form,
a tenth routine that calculates a rewards points value or other incentive for the different product or service based on the extracted product information; and
an eleventh routine that posts the calculated points value or other incentive to the new or existing account associated with the different product or service.

12. The software system of claim 11 wherein the eighth routine is carried out automatically following the seventh routine.

13. The software system of claim 11 wherein the eighth routine is carried out by a command following the seventh routine.

14. The software system of claim 9 wherein the proof of purchase is a register receipt.

15. The software system of claim 9 wherein the proof of purchase is in the form of electronically transmitted information.

16. The software system of claim 11 wherein the proof of purchase is a register receipt.

17. An application accessed consumer rewards program method comprising the steps of:
accessing a consumer rewards application;
establishing a new account or creating a link between the consumer rewards application and an existing account;
accessing the consumer rewards application;
capturing an image of a proof of purchase for a product or service;
transmitting the image to a remote device;
determining, on the remote device, a type of information on the proof of purchase and, if the information is direct machine readable,
extracting product or service information from the proof of purchase, and if the information on the proof of purchase is not direct machine readable, converting the information into a direct machine readable form;
calculating a rewards points value or other incentive based on the extracted product information; and
posting the calculated points value or other incentive to the new or existing account.

18. The rewards program of claim 17 wherein the steps of capturing the image and transmitting the images are carried out on a smart device.

19. The rewards program of claim 18 including the step of transmitting from the remote device one or more messages to acknowledge receipt of the image, validation and/or processing of the rewards point value, and posting of the calculated points value or other incentive to the new or existing account.

20. The rewards program of claim 17 wherein the step of transmitting the image is carried out by upload to a server by accessing the consumer rewards application through a web application.

21. The rewards program of claim 17 wherein the step of transmitting the image is carried out by transmitting through a text message.
